(19) United States
(12) Patent Application Publication
(10) Pub. No.: US 2025/0132367 A1
(43) Pub. Date: Apr. 24, 2025

(54) FUEL CELL COMPRISING AN END PLATE COMPRISING A MAIN DEVICE AND AN AUXILIARY DEVICE, METHOD FOR ACCESSING A FUEL CELL SHAFT

(71) Applicant: SAFRAN POWER UNITS, TOULOUSE (FR)

(72) Inventors: Romain QUINTON, MOISSY-CRAMAYEL (FR); Sofyane ABBOU, MOISSY-CRAMAYEL (FR); Patrice Daniel Claude BUSO, MOISSY-CRAMAYEL (FR)

(73) Assignee: SAFRAN POWER UNITS, TOULOUSE (FR)

(21) Appl. No.: 18/699,758

(22) PCT Filed: Oct. 3, 2022
(86) PCT No.: PCT/EP2022/077483

§ 371 Date: Oct. 30, 2024

(30) Foreign Application Priority Data
Oct. 11, 2021 (FR) FR2110717

(51) Int. Cl. H01M 8/248; H01M 8/2483

(52) U.S. Cl. CPC H01M 8/248; H01M 8/2483; H01M 2250/20

(57) ABSTRACT

The invention relates to a fuel cell (1) comprising a stack (2) comprising a plurality of cells and a plurality of fluid flow shafts, two end plates (3) and a plurality of traction members, at least one end plate (3) has a main device (5) having at least one access opening (51) aligned with a flow shaft and at least one main traction member (T1) configured to apply a main compression to a main body so as to urge the main body (50) against the stack (2) at the flow shaft, and an auxiliary device (6) configured to urge an auxiliary body against the stack (2), the auxiliary compression being applied at a distance from the flow shaft of the stack (2), the main device (5) being mounted removably with respect to the auxiliary device (6).

### TECHNICAL FIELD

The present invention relates to the field of repairing fuel cells, in particular, on board an aircraft in order to provide propulsion and non-propulsion energy.

A fuel cell is used to produce electrical energy from an electrochemical reaction between different fluids. Typically, a fuel cell is supplied with hydrogen and oxygen, which react in the fuel cell to generate electrical energy. A fuel cell comprises a stack comprising a plurality of cells aligned along a stack axis. The stack of the cells enables the electrochemical reaction from the fluids.

Each cell consists of an ion-conductive electrolyte surrounded by two electrodes, which in turn are surrounded by interconnecting plates. By way of example, in the case of a fuel cell of the proton exchange membrane type known by its abbreviation PEMFC for “Proton Exchange Membrane Fuel Cell”, the electrolyte is in the form of a proton-conducting polymer membrane and the electrodes are in the form of a porous medium carrying a catalyst such as platinum. The electrolyte and electrode assembly is called Membrane Electrode Assembly, known by its abbreviation MEA. Each MEA is brought into contact with reactant gases on its two opposite sides (for example hydrogen and oxygen, which may be present in the air) through the interconnecting plates to form a cell.

In a known manner, the assembly of two interconnecting plates, belonging to two adjacent cells, is called a bipolar plate. Thus, a bipolar plate is inserted between the cathode of an MEA and the anode of the adjacent MEA. On the one hand, a bipolar plate supplies a first MEA on the anode side with fuel (hydrogen) and, on the other hand, a second MEA on the cathode side with oxidizer (oxygen). In general, each bipolar plate comprises an internal cooling circuit wherein a heat transfer fluid circulates to provide heat or extract the heat produced by the exothermic reaction.

The current generated by the cells is recovered at both ends of the stack by so-called collector conductor plates. The electrical power delivered by the fuel cell is a function of the number of cells (delivered voltage capacity), the active surface area of the cells (delivered current capacity) and the flow rates of the reactant fluids (importance of the electrochemical reaction that produces the current).

The entire stack of cells is kept compressed between two so-called end plates connected by tie rods that hold the assembly and guarantee the sealing of the stack. This sealing is provided by seals inserted between the bipolar plates and the MEAs of the cells. The end plates are conventionally solid because they must apply uniform pressure on the surface of the cells and be dimensionally stable under the effect of internal pressure of the stack and temperature fluctuations.

The reactant and heat transfer fluids are introduced and discharged at the end plates which distribute them in flow shafts passing through the stack. These flow shafts result from the stack of openings formed in the cells. By way of example, three shafts introduce the fluids from one side of the stack (two reactant fluids and one heat transfer fluid if necessary) to transit into the cells while three other shafts discharge the fluids from another side of the stack.

In reference to FIG. 1, a fuel cell 101 is shown comprising a stack 102 comprising a plurality of cells aligned along a stack axis X. Tie rods 104 connect an outer portion of the end plates 103 peripherally in order to apply a constant compressive force on the stack 102. The end plates 103 comprise flow lines 130 that lead into the flow shafts of the stack 102.

During the electrochemical reaction in the fuel cell 101, the reactant fluids become charged with traces of acid which are part of the composition of the MEAs. These traces of phosphoric acid are present in the flow shafts corresponding to the outlets of the two fuel fluid circuits, in particular in the form of water vapor in the case of a high-temperature fuel cell. This acid may crystallize, especially during a fuel cell start/stop step during which the temperature is below the normal operating temperature, which may block the flow channels. Such a blockage may cause damage which may lead to hot spots with the risk of perforation of the MEA. In addition to a loss of efficiency of the fuel cell, the likelihood of fire and leakage risks is increased.

In order to avoid a malfunction of the fuel cell 101, the flow shafts of the stack 102 must be inspected and cleaned. In practice, it is necessary to remove the end plates 103 to access the shafts of the stack 102, clean the stacks, and replace the end plates 103. Removal of the end plates 103 leads to a pressure loss that irreparably destructures the stack 102 of the cells, resulting in an overall loss of sealing, pollution of the membranes by the heat transfer fluid and a misalignment of the cells of the stack 102. In other words, cleaning the stacks may lead to significant disadvantages that preclude any recommissioning of the fuel cell 101.

An immediate solution would be to inspect the shafts by the flow lines 130 formed in the end plates 103, but these circulation lines 130 generally have a smaller diameter than the diameter of the shafts, which prevents optimal inspection/cleaning.

In addition, the flow lines 130 formed in the end plates 103 may be bent (FIG. 1), making it impossible to pass tools for inspection or cleaning, for example, an endoscope or pipette with resin.

An objective of the present invention is to allow the flow shaft of a stack to be inspected and cleaned conveniently and quickly without deteriorating the structure of the stack.

### DESCRIPTION OF THE INVENTION

The invention relates to a fuel cell comprising a stack comprising a plurality of cells aligned along a stack axis X and a plurality of fluid flow shafts in the stack, two end plates placed at the ends of the stack along the stack axis X, and a plurality of traction members connecting the end plates to each other in order to compress the stack.

The fuel cell is remarkable in that at least one end plate comprises:
a main device comprising a main body comprising at least one access opening aligned with a flow shaft and at least one main traction member configured to apply a main compression to the main body so as to urge the main body against the stack at the flow shaft of the stack and
an auxiliary device comprising an auxiliary body and at least one auxiliary traction member configured to apply an auxiliary compression to the auxiliary body so as to urge the auxiliary body against the stack, the auxiliary compression being applied at a distance from the flow shaft of the stack, the main device being mounted removably with respect to the auxiliary device.

Thanks to the invention, the end plate is configured to apply two separate and independent compressions. The main device may be removed in a removable way to allow access to the flow shafts. Advantageously, the auxiliary device makes it possible to provide sufficient compression avoiding destructuring of the stack. A loss of sealing, alignment or pollution of the stack are advantageously avoided. Since the auxiliary compression is carried out at a distance from the flow shaft, the auxiliary device does not hinder access to the flow shaft, which allows convenient cleaning of the latter.

Preferably, each end plate comprises a main device and an auxiliary device. The end plates advantageously have an identical structure to ensure homogeneous compression. The main traction members are mounted between opposite main devices. The auxiliary traction members are mounted between opposite auxiliary devices.

Preferably, the stack comprising a central part and a peripheral part in which the flow shafts are formed, the auxiliary body is configured to apply the auxiliary compression mostly on the central part of the stack. Thus, the auxiliary compression is applied at a distance from the flow shafts.

According to one aspect of the invention, the auxiliary body comprises a central part and at least one tab extending protruding with respect to the central part, the auxiliary traction member being mounted in the tab. The tab allows traction to be carried out without crossing the stack, outside the latter. The auxiliary traction member exerts a force on the tab without exerting a force on the main device.

Preferably, the stack comprising a central part and a peripheral part wherein the flow shafts are formed, the main body is configured to apply the main compression mostly on the peripheral part of the stack. Thus, the main compression allows a constraint to be exerted directly on the flow shafts.

Preferably, the main body comprises an indentation configured to cooperate by form-fitting with the auxiliary body such that the end plate applies a distributed plane force.

Preferably, the main compression is higher than the auxiliary compression in order to ensure a high uniform compression.

Preferably, the main body is peripheral in order to apply a force on the flow shafts. According to one aspect, the main body partially covers the auxiliary body in order to apply a supplementary force to the stack on separate parts. According to another aspect, the main body completely covers the auxiliary body.

According to one aspect of the invention, the auxiliary body comprises meshes configured to apply the auxiliary compression to the stack, the meshes defining openings through which the flow shafts are accessible. Thus, the auxiliary body allows exerting a compression force which is distributed over the stack while ensuring accessibility to the flow shafts through the meshes.

Preferably, the access opening has a lower cross-section than that of the flow shaft. Thus, the main body may exert a main compression force over the entire periphery of the flow shaft.

Preferably, the auxiliary traction member is in the form of a spring leaf configured to generate the auxiliary compression. The use of a plurality of spring leaves makes it possible to exert a plurality of independent and distributed compression forces.

Preferably, the end plate is configured to no longer generate tension in the auxiliary traction members during compression performed by the main traction members. The auxiliary traction members are configured to be removable when the main device is in place.

According to one aspect of the invention, the auxiliary body comprises at least one gutter on which the spring leaf is mounted. The spring leaves may be conveniently installed/removed without tools. The spring leaves may accommodate the pressurization of the stack and be removed once the main device has been mounted.

The invention also relates to a method for accessing at least one flow shaft of a stack of a fuel cell such as presented previously, the end plates compressing the stack, at least one end plate comprising a main device applying a main compression urging the main body against the stack at the flow shaft of the stack and an auxiliary device applying an auxiliary compression urging the auxiliary body against the stack at a distance from the flow shaft of the stack, the method comprising a step consisting of:
Removing the main device in order to stop the main compression so as to uncover an access to the flow shaft, the auxiliary device maintaining the auxiliary compression.

The auxiliary compression is applied at the periphery of the flow shafts and at a distance from the latter, which makes it possible to avoid destructuring the stack without obstructing access to the flow shafts.

Preferably, the method comprises a step of inspecting the flow shaft following removal of the main device, in particular, in order to perform cleaning or repair.

The invention also relates to a method comprising, prior to the removal step, a step consisting of:
Fitting an auxiliary traction member to apply auxiliary compression urging the auxiliary body of the auxiliary device against the stack at a distance from the flow shaft of the stack.

Preferably, the auxiliary traction member is mounted between two auxiliary devices belonging to opposite end plates.

Advantageously, the auxiliary traction member is only installed during a maintenance operation, which makes it possible to limit the mass and cost of the fuel cell during its normal operation. The same auxiliary traction member may advantageously be used for different fuel cells.

### DESCRIPTION OF THE FIGURES

The invention will be better understood upon reading the following description, given as an example, and referring to the following figures, given as non-limiting examples, wherein identical references are given to similar objects.

FIG. 1 is a schematic representation of a fuel cell according to the prior art.

FIG. 2 is a schematic representation of a fuel cell according to a first embodiment.

FIG. 3 is a schematic representation of a close-up portion of a portion of an endplate comprising a main device and an auxiliary device.

FIG. 4 is a schematic representation of FIG. 3 without the main device.

FIG. 5 is a schematic representation of FIG. 3 without the auxiliary device,

FIG. 6 is a schematic representation of the fluid flow shafts formed in a stack.

FIG. 7 is a schematic representation of a fuel cell according to a second embodiment.

FIG. 8 is a schematic representation of FIG. 7 without the main devices.

FIG. 9 is a schematic representation of FIG. 7 without the collector plates and the stack.

FIG. 10 is a schematic representation of an end plate according to a second embodiment seen from below.

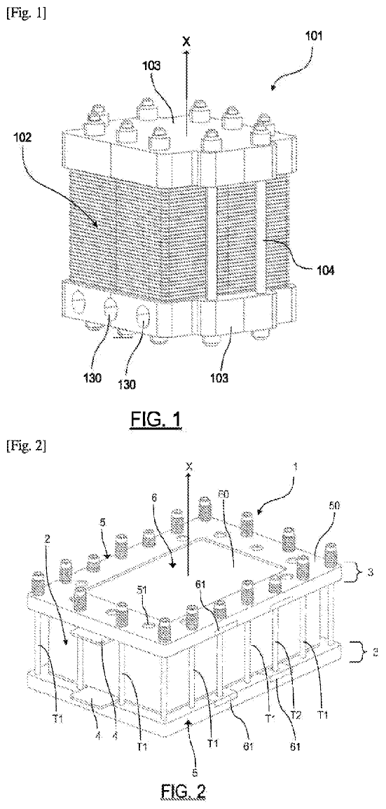

It should be noted that the figures set out the invention in detail in order to implement the invention, said figures may of course be used to better define the invention where applicable.

### DETAILED DESCRIPTION OF THE INVENTION

The invention relates to the field of fuel cells of the proton-exchange membrane type known under its abbreviation PEMFC for “Proton-Exchange Membrane Fuel Cell”. Preferably, the fuel cell is on board an aircraft in order to supply power to propulsion equipment.

In reference to FIG. 2, a fuel cell 1 is shown comprising a stack 2 comprising a plurality of cells aligned along a stack axis X. Each cell comprises a plurality of fluid flow openings, said fluid flow openings being aligned parallel to the stack axis X in order to form a plurality of fluid flow stacks 20 in the stack 2 (FIGS. 4 to 6).

The stack 2 of the cells allows the electrochemical reaction from fluids, in particular, hydrogen and oxygen. In this example, each cell comprises a Membrane Electrode Assembly, known by its abbreviation MEA. Each MEA is brought into contact with reactant gases on its two opposite sides (for example hydrogen and oxygen which may be present in the air) through the interconnecting plates to form a cell. In a known manner, the assembly of two interconnecting plates, belonging to two adjacent cells, is called a bipolar plate. Thus, a bipolar plate is inserted between the cathode of an MEA and the anode of the adjacent MEA. Thus, a bipolar plate supplies on the one hand fuel (hydrogen) to a first MEA and, on the other hand, a second MEA on the cathode side with oxidizer (oxygen). In general, each bipolar plate comprises an internal cooling circuit wherein a heat transfer fluid circulates to provide heat or extract the heat produced by the exothermic reaction. Such a stack 2, formed of an alternation of MEAs and bipolar plates, is known from the prior art and will not be presented in more detail.

In this example, in reference to FIG. 2, the fuel cell 1 further comprises collector plates 4, positioned at the ends of the stack 2, so as to collect the current generated by the cells. In a known manner, the electrical power delivered by the fuel cell 1 is a function of the number of cells (delivered voltage capacity) and the flow rates of the reactant fluids (importance of the electrochemical reaction that produces the current).

In reference to FIG. 2, the fuel cell 1 further comprises two end plates 3 placed at the ends of the stack 2 along the stack axis X and a plurality of traction members connecting the end plates 3 to each other in order to compress the stack 2.

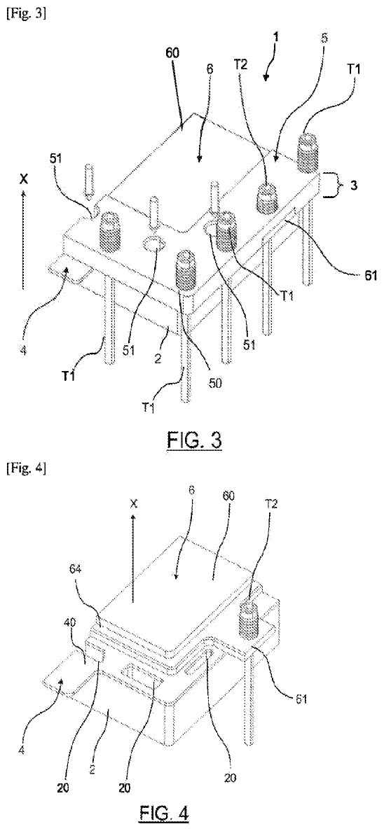

According to the invention, in reference to FIG. 3, at least one end plate 3 comprises:
a main device 5 comprising a main body 50 comprising at least one access opening 51 aligned with a flow shaft 20 (FIG. 4) and at least one main traction member T1 configured to apply a main compression to the main body 50 so as to urge the main body 50 against the stack 2 at the flow shaft 20 of the stack 2 and
an auxiliary device 6 comprising an auxiliary body 60 and at least one auxiliary traction member T2 configured to apply an auxiliary compression to the auxiliary body 60 so as to urge the auxiliary body 60 against the stack 2, the auxiliary compression being applied at a distance from the flow shaft 20 of the stack 2, the main device 5 being mounted removably with respect to the auxiliary device 6.

Thanks to the invention, the main device 5 may be removed to access the fluid flow shaft 20. The main compression is no longer applied to the stack 2, but the latter is not destructured since the auxiliary device 6 always provides an auxiliary compression. Since the auxiliary compression is carried out at a distance from the flow shaft 20, the auxiliary device 6 does not hinder access to the flow shaft 20, which allows practical cleaning of the latter as will be presented later.

In this first embodiment, in reference to FIG. 3, the main device 5 is configured to partially cover the auxiliary device 6 in the mounted position, but it goes without saying that it could also cover it completely. As shown in FIG. 4, the auxiliary device 6 comprises a shoulder 64 on which the main device 5 may rest to exert a force. As will be presented later on, the compression force applied by the main device 5 may supplement the compression force applied by the auxiliary device 6 or completely supersede it.

In reference to FIG. 3, the main body 50 comprises three access openings 51 that are aligned with the flow shafts 20 of the stack 2. The main body 50 is peripheral and comprises an inner opening wherein the auxiliary device 6 is mounted. Preferably, the main device 5 comprises inner lines each comprising an access opening 51 leading into a flow shaft 20 and an outer opening suitable to receive an outer fluid connector. As explained previously, the inner lines may be straight or bent and lead into the thickness of the main body 50.

In this example, the stack 2 comprises a peripheral part wherein the flow shafts 20 are formed and a central part which is devoid of them, the central part forming the active zone of the stack 2.

The main device 5 further comprises a plurality of main traction members T1 so as to apply a main compression to the stack 2 against the flow stacks 20 of the stack 2. In particular, the main body 50 applies a force against the periphery of the opening of the flow shaft 20. Preferably, the access opening 51 has a smaller cross-section than the flow shaft 20 such that the main body 50 may be in continuous contact with the peripheral edge of the opening of the flow shaft 20. In other words, the main compression is applied to the immediate vicinity of the flow shafts 20, which ensures optimum compression. In this example, more than about ten main traction members T1 are used to ensure a main compression that is distributed. The main device 5 comprises passage openings wherein the main traction members T1 are mounted, in particular tie rods connected to the other end plate 3 as shown in FIG. 2, it goes however without saying that other traction members may be suitable.

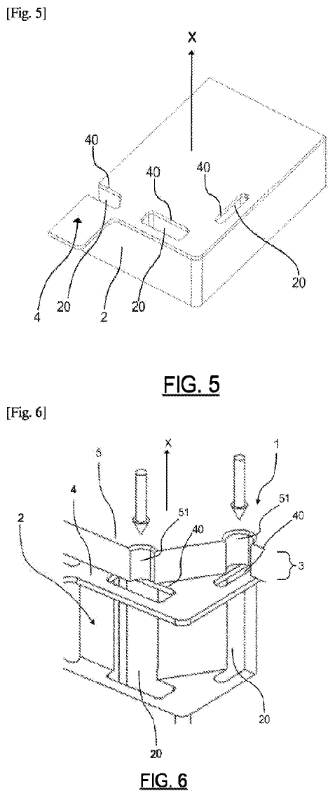

As shown in FIGS. 4 and 5, the main compression is applied to the flow shafts 20 of the stack 2 via the collector plate 4 which comprises orifices 40 so as to allow fluid communication between the access openings 51 and the flow shafts 20 of the stack 2.

In this first embodiment, in reference to FIGS. 3 and 4, the auxiliary device 6 comprises an auxiliary body 60 configured to apply an auxiliary compression to the stack 2 at a distance from the flow shafts 20, in particular, in the central part of the stack 2 along the stack axis X. In this example, the auxiliary body 60 comprises auxiliary traction members T2 in the form of tie rods which are mounted in tabs 61 extending protruding from the auxiliary body 60 and which are configured to be connected to another end plate 3. Preferably, the auxiliary traction members T2 are fewer than the main traction members T1 and are configured to apply an auxiliary compression lower than the main compression but sufficient to avoid destructuring the stack 2. Advantageously, the auxiliary device 6 makes it possible to apply an auxiliary compression while leaving the access to the flow shafts 20 uncovered when the main device 5 has been removed in a removable manner.

An example embodiment of a method for accessing a flow shaft will now be presented.

As show in FIGS. 2 and 3, in the initial position, the end plate 3 is mounted on the stack 2, the auxiliary device 6 applies an auxiliary compression centrally while the main device 5 applies a main compression peripherally on the stack 2 along the stack axis X. Advantageously, the main device 5 allows direct compression of each flow shaft 20. The main compression is preferably higher than the auxiliary compression.

As previously presented, the main device 5 applies the compression on the auxiliary device 6 via the shoulder 64 but it goes without saying that the compression could be performed separately.

According to a first aspect, the main device 5 applies an additional compression on the auxiliary device 6 and all traction members T1, T2 are tensioned when the main device 5 is in place. According to a second aspect, the main device 5 applies a compression that supersedes that of the auxiliary device 6. As a result, the auxiliary traction members T2 are not tensioned when the main device 5 is in place.

The method comprises a step consisting of deactivating the main traction members T1 so as to stop the main compression and a step consisting of removing the main device 5. The removal of the main device 5 causes the main compression to disappear but does not destructure the stack 2 since the auxiliary device 6 still provides an auxiliary compression. Preferably, as the main device 5 is loosened, the auxiliary traction members T2 are tensioned and take up more and more force. The auxiliary compression is not applied directly on the flow shafts 20 but at a distance from them. Thus, the flow shafts 20 are directly accessible for an operator who may then inspect them, clean them or perform a repair. The stack 2 remains sealed, which avoids any risk of pollution or misalignment of the cells of the stack 2.

In other words, to perform a maintenance operation, the auxiliary device 6 remains in place with its auxiliary traction members T2, the operator advantageously only acts on the main traction members T1. The operator may thus insert a syringe, an endoscope or any other device into the flow shaft 20 the inner surface of which is fully and easily accessible.

The use of an end plate 3 with a removable main device 5 allows a risk-free maintenance operation for the fuel cell 1 to be carried out, in particular to remove any acid crystallizations.

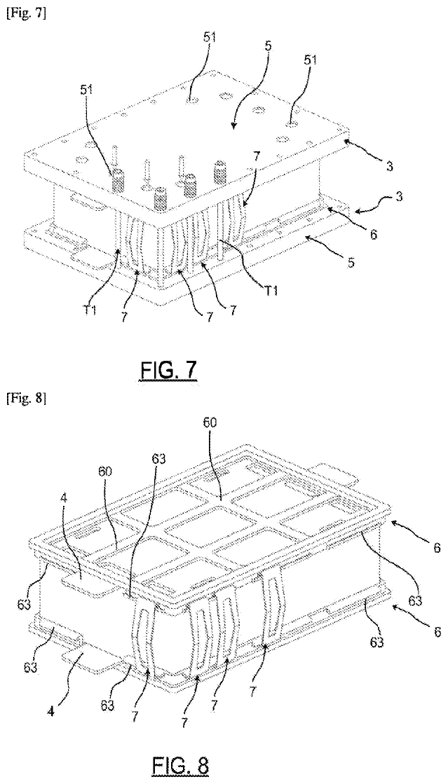

In reference to FIGS. 7 to 10, according to a second embodiment, the end plate 3 has a different structure. In particular, in this second embodiment, the main device 5 is configured to completely cover the auxiliary device 6 in the mounted position as shown in FIG. 7, but it goes without saying that it could also partially cover it.

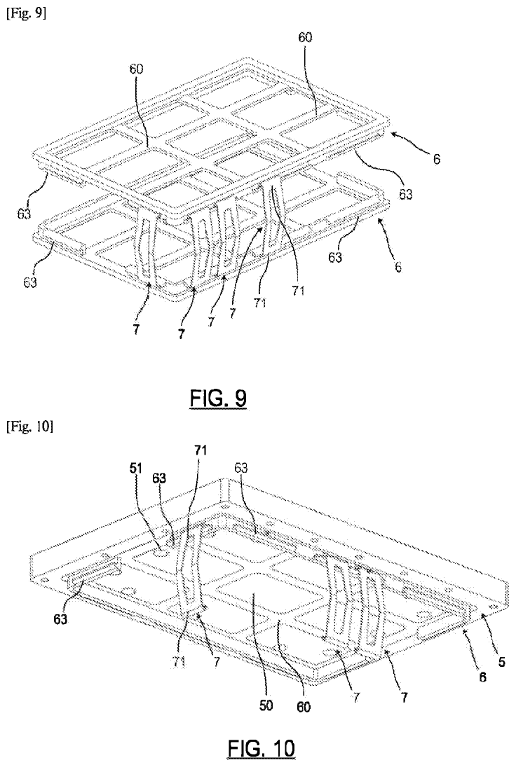

In this second embodiment, in reference to FIGS. 8 and 9, the auxiliary device 6 comprises an auxiliary body 60 formed of meshes internally delimiting wide openings from which the flow shafts 20 are accessible. In this example, the auxiliary body 60 extends to the peripheral edge of the stack 2 so as to ensure a distributed auxiliary compression, which is advantageous for ensuring the sealing of the stack 2. In reference to FIG. 10, the main body 50 comprises an indentation to cooperate by form-fitting with the auxiliary body 60.

In order to ensure the auxiliary compression, the auxiliary device 6 comprises auxiliary traction members T2 in the form of spring leaves 7 configured to cooperate with the opposite end plate 3, in particular, with the auxiliary device 6 of the opposite end plate 3 as shown in FIG. 8. In this example, the auxiliary body 60 comprises several gutters 63 on its outer edge on which the spring leaves 7 are mounted, in particular, distributedly.

As shown in FIGS. 9 and 10, each spring leaf 7 has two ends 71 that are connected to the gutters 63 of the auxiliary devices 6 of the end plates 3. Each end 71 preferably has a hook shape such that it may be conveniently connected to a gutter 63, in particular, when the main device 5 is in place. Preferably, each spring leaf 7 is added in order to limit its mass. The spring leaves 7 make it possible to perform traction on the gutters 63 in order to perform an auxiliary compression by the auxiliary devices 6 on the stack 2. Preferably, each spring leaf 7 is symmetrical to allow convenient and quick assembly.

It goes without saying that the auxiliary body 60 of the auxiliary device 6 could alternatively comprise protruding tabs with auxiliary traction members T2 as presented for the first embodiment.

Similar to previously, the main device 5 may apply an additional compression to the auxiliary device 6 and the spring leaves 7 are tensioned when the main device 5 is in place. Preferably, the main device 5 applies a compression that supersedes that of the auxiliary device 6. As a result, the spring leaves 7 are not tensioned when the main device 5 is in place. Thus, the spring leaves 7 may be removed when the main device 5 is in place and used only during maintenance operations. Advantageously, this makes it possible to reduce the mass and the cost of a fuel cell. Preferably, the spring leaves 7 may be used successively with several different fuel cells 1 during the maintenance thereof.

When the main device 5 is loosened, the height of the stack 2 may increase, as the spring leaves 7 elongate to compensate for this height increase while maintaining a sufficient auxiliary compression force.

A method for accessing a flow shaft 20 may be implemented in a manner analogous to the first embodiment since the mesh auxiliary body 60 comprises openings enabling, on the one hand, an auxiliary compression to be achieved on the stack 2 and, on the other hand, easy access to each flow shaft 20 through the meshes. During the maintenance operation, the spring leaves 7 provide the auxiliary compression in a distributed manner ensuring optimum sealing.

Thanks to the invention, a maintenance operation (cleaning, repair or other) may be carried out ergonomically, conveniently and quickly.

1. Fuel cell (1) comprising a stack (2) comprising a plurality of cells aligned along a stack axis (X) and a plurality of fluid flow shafts (20) in the stack (2), two end plates (3) placed at the ends of the stack (2) along the stack axis (X), and a plurality of traction members connecting the end plates (3) to each other in order to compress the stack (2), fuel cell (1) characterized in that at least one end plate (3) comprises:
a main device (5) comprising a main body (50) comprising at least one access opening (51) aligned with a flow shaft (20) and at least one main traction member (T1) configured to apply a main compression to the main body (50) so as to urge the main body (50) against the stack (2) at the flow shaft (20) of the stack (2) and
an auxiliary device (6) comprising an auxiliary body (60) and at least one auxiliary traction member (T2) configured to apply an auxiliary compression to the auxiliary body (60) so as to urge the auxiliary body (60) against the stack (2), the auxiliary compression being applied at a distance from the flow shaft (20) of the stack (2), the main device (5) being mounted removably with respect to the auxiliary device (6), the main device (5) being configured to be removed when the auxiliary traction member (T2) applies an auxiliary compression to the auxiliary body (60).

2. Fuel cell (1) according to claim 1, wherein, the stack (2) comprising a central part and a peripheral part in which the flow shafts (20) are formed, the auxiliary body (60) is configured to apply the auxiliary compression mostly on the central part of the stack (2).

3. Fuel cell (1) according to claim 2 wherein, the auxiliary body (60) comprises a central part and at least one tab (61) extending protruding with respect to the central part, the auxiliary traction member (T2) being mounted in the tab (61).

4. Fuel cell (1) according to any one of claims 1 to 3, wherein, the stack (2) comprising a central part and a peripheral part in which the flow shafts (20) are formed, the main body (50) is configured to apply the main compression mostly on the peripheral part of the stack (2).

5. Fuel cell (1) according to claim 4, wherein, the main body (5) is peripheral.

6. Fuel cell (1) according to one of claims 3 to 5 wherein, the auxiliary body (60) comprises meshes configured to apply the auxiliary compression on the stack (2), the meshes defining openings through which the flow shafts (20) are accessible.

7. Fuel cell (1) according to any one of claims 1 to 6, wherein the access opening (51) has a cross-section smaller than that of the flow shaft (20).

8. Fuel cell (1) according to one of claims 1 to 7, wherein the auxiliary traction member (T2) is in the form of a spring leaf (7) configured to generate the auxiliary compression.

9. Fuel cell (1) according to claim 8, wherein the auxiliary body (60) comprises at least one gutter (63) on which the spring leaf (7) is mounted.

10. Method for accessing at least one flow shaft (20) of a stack (2) of a fuel cell (1) according to one of claims 1 to 9, the end plates (3) compressing the stack (2), at least one end plate (3) comprising a main device (5) applying a main compression urging the main body (50) against the stack (2) at the flow shaft (20) of the stack (2) and an auxiliary device (6) applying an auxiliary compression urging the auxiliary body (60) against the stack (2) at a distance from the flow shaft (20) of the stack (2), method comprising a step consisting of:
Removing the main device (5) in order to stop the main compression so as to uncover access to the flow shaft (20), the auxiliary device (6) maintaining the auxiliary compression.
